(19) United States
(12) Patent Application Publication
(10) Pub. No.: US 2019/0113812 A1
(43) Pub. Date: Apr. 18, 2019

(54) METHOD FOR PRODUCING LIQUID CRYSTAL PANEL

(71) Applicant: SHARP KABUSHIKI KAISHA, Sakai City, Osaka (JP)

(72) Inventors: ISAMU MIYAKE, Sakai City (JP); AKIRA HIRAI, Sakai City (JP)

(21) Appl. No.: 16/090,256

(22) PCT Filed: Mar. 23, 2017
(86) PCT No.: PCT/JP2017/011572

§ 371 Date: Sep. 30, 2018

(30) Foreign Application Priority Data
Mar. 30, 2016 (JP) 2016-067586

(51) Int. Cl. G02F 1/1337

(52) U.S. Cl. CPC G02F 1/133788; G02F 1/133723; C08L 33/02; G02F 2001/133757; G02F 1/133753

(57) ABSTRACT

A method for producing a liquid crystal panel of the present invention is a method for producing a liquid crystal panel including paired substrates, a liquid crystal layer between the substrates, and a horizontal photo-alignment film between at least one of the substrates and the liquid crystal layer, the method including the steps of: forming a film containing a polymer having a specific structure on a surface of at least one of the substrates; and irradiating the film with S-polarized light from a direction oblique to the normal to the substrate surface to perform an alignment treatment on the film and thereby form a horizontal photo-alignment film, wherein the horizontal photo-alignment, film aligns liquid crystal molecules perpendicularly to the polarization direction of light applied from the substrate normal.

### TECHNICAL FIELD

The present invention relates to methods for producing liquid crystal panels. In particular, the present invention relates to a method for producing a liquid crystal panel in which a photo-alignment film controls the alignment of liquid crystal molecules.

### BACKGROUND ART

Liquid crystal display devices are display devices utilizing a liquid crystal composition for display. The typical display mode thereof is irradiating a liquid crystal panel containing a liquid crystal composition sealed between paired substrates with light from a backlight and applying voltage to the liquid crystal composition to change the alignment of liquid crystal molecules, thereby controlling the amount of light passing through the liquid crystal panel. Such liquid crystal display devices have features including a thin profile, light weight, and low power consumption, and have therefore been used for electronic devices such as smartphones, tablet PCs, and car navigation systems. The liquid crystal panel can be applied to liquid crystal flat antennas as well as to liquid crystal display devices.

In liquid crystal panels, the alignment of liquid crystal molecules with no voltage applied is typically controlled by alignment films on which an alignment treatment has been performed. The alignment treatment has conventionally been performed by the rubbing method of rubbing the surface of an alignment film with a tool such as a roller. However, since the number of the conductive lines and the area of the black matrix disposed in the liquid crystal panel have been increased, irregularities are now more likely to occur on the substrate surfaces in the liquid crystal panel. With irregularities on the substrate surfaces, the portions near the irregularities may not be properly rubbed by the rubbing method. Such a non-uniform alignment treatment causes a reduction in contrast ratio in the liquid crystal display device, or causes a reduction in gain in the liquid crystal flat antenna.

In order to deal with this problem, studies and development have been made on a photo-alignment method which is an alternative alignment treatment method to the rubbing method and irradiates the surface of an alignment film with light. With the photo-alignment method, an alignment treatment can be performed without contact with the surface of the alignment film. The photo-alignment method therefore has the advantage that the alignment treatment is less likely to be non-uniform even with irregularities on the substrate surfaces, so that a favorable liquid crystal alignment can be achieved on the entire substrates.

Regarding the photo-alignment method, for example, Non-Patent Literature 1 discloses two-step irradiation, in which a polyvinyl cinnamate (PVCi) film is irradiated with polarized ultraviolet light from the normal direction and then from an oblique direction. Patent Literature 1 discloses light exposure of a photo-alignment polymer network material that aligns parallel to the polarization direction of the light for exposure, wherein the exposure is performed such that the light incident direction is not parallel to the normal to the surface of the photo-alignment layer.

### CITATION LIST

### Patent Literature

Patent Literature 1: JP 2980558 B

### Non-Patent Literature

Non-Patent Literature 1: T. Hashimoto, T. Sugiyama, K. Katoh, T. Saitoh, H. Suzuki, Y. Iimura, S. Kobayashi, “TN-LCD with Quartered Subpixels Using Polarized UV-Light-Irradiated Polymer Orientation Films”, Society for information Display DIGEST (U.S.), 1995, 41.4

### SUMMARY OF INVENTION

### Technical Problem

Current mass-produced liquid crystal display devices mainly include horizontal photo-alignment films prepared from an alignment film material that aligns liquid crystal molecules perpendicularly to the incident polarized light. There thus has been a demand for a method for producing a liquid crystal panel that gives a pre-tilt angle to liquid crystal molecules in a simple manner using the alignment film material whose long-term reliability is ensured, and that is also less likely to cause disclination.

In Non-Patent Literature 1, while an alignment film material that aligns liquid crystal molecules perpendicularly to polarized light is used, two-step light exposure is required. In Patent Literature 1, studies are made on an exposure method for alignment film materials that align liquid crystal molecules parallel to polarized light.

The present invention was made in view of the above state of the art, and aims to provide a method for producing a liquid crystal panel that can give a pre-tilt angle to liquid crystal molecules in a simple manner using a horizontal photo-alignment film and that is also less likely to cause disclination.

### Solution to Problem

The present inventors made studies on the method for performing a photo-alignment treatment in a simple manner using an alignment film material that aligns liquid crystal molecules perpendicularly to polarized light. They found that a pre-tilt angle can be given to liquid crystal molecules, and also disclination can be reduced, by forming a film containing a polymer having a specific structure and exposing the film to S-polarized light from a direction oblique to the substrate surface. The present inventors thus have found the solution of the above problems, arriving at the present invention.

One aspect of the present invention may be a method for producing a liquid crystal panel including paired substrates, a liquid crystal layer between the substrates, and a horizontal photo-alignment film between at least one of the substrates and the liquid crystal layer, the method including the steps of: forming a film containing a polymer having a structure represented by the following formula (1):

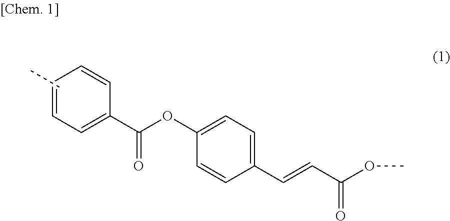

on a surface of at least one of the substrates; and irradiating the film with S-polarized light from a direction oblique to the normal to the substrate surface to perform an alignment treatment on the film and thereby form a horizontal photo-alignment film, wherein the horizontal photo-alignment film aligns liquid crystal molecules perpendicularly to the polarization direction of light applied from the substrate normal.

### Advantageous Effects of Invention

The method for producing a liquid crystal panel of the present invention can give a pre-tilt angle to liquid crystal molecules in a simple manner using a horizontal photo-alignment film and also can provide a liquid crystal panel that is less likely to cause disclination.

### BRIEF DESCRIPTION OF DRAWINGS

FIG. 1 is a schematic cross-sectional view of a liquid crystal panel.

FIG. 2 is a view illustrating an S-polarized light irradiation method.

FIG. 3 is a view illustrating S-polarized light.

FIG. 4 is a view illustrating the relation between the polarization direction of light applied from the substrate normal and the alignment azimuth of liquid crystal molecules.

### DESCRIPTION OF EMBODIMENTS

Hereinafter, an embodiment of the present invention is described. The contents of the following embodiment are not intended to limit the scope of the present invention, and the design may appropriately be changed within the spirit of the configuration of the present invention.

The method for producing a liquid crystal panel of Embodiment 1 is a method for producing a liquid crystal panel including paired substrates, a liquid crystal layer between the substrates, and a horizontal photo-alignment film between at least one of the substrates and the liquid crystal layer.

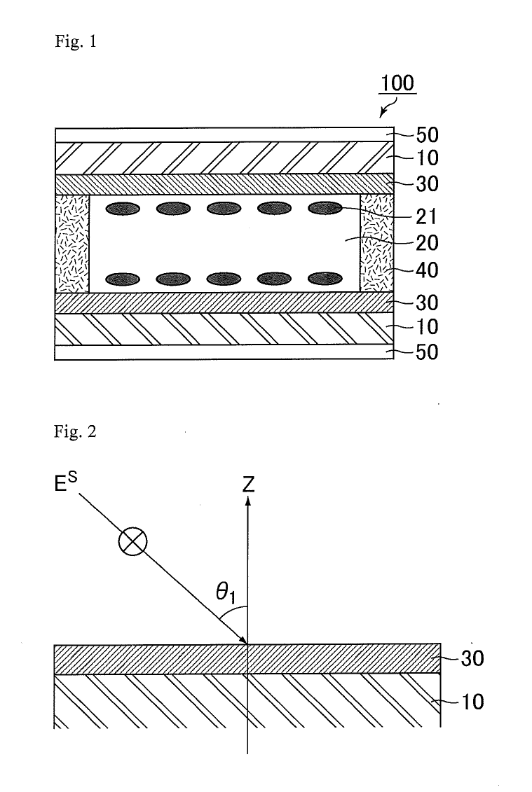

With reference to FIG. 1, a liquid crystal panel obtained by the method for producing a liquid crystal panel of Embodiment 1 will be described. FIG. 1 is a schematic cross-sectional view of a liquid crystal panel. As shown in FIG. 1, a liquid crystal panel 100 includes paired substrates 10, a liquid crystal layer 20 between the substrates 10, and a horizontal photo-alignment film 30 between at least one of the substrates 10 and the liquid crystal layer 20.

The paired substrates 10 may be, for example, a combination of an active matrix substrate (TFT substrate) and a color filter (CF) substrate.

The active matrix substrate may be one commonly used in the field of liquid crystal panels. When the active matrix substrate is seen in a planar view, for example, the active matrix substrate has on a transparent substrate a structure which includes multiple parallel gate signal lines, multiple source signal lines extending in a direction perpendicular to the gate signal lines and formed in parallel to each other, active elements such as thin-film transistors (TFTs) arranged at positions corresponding to the intersections between the gate signal lines and the source signal lines, and pixel electrodes arranged in a matrix in regions partitioned by the gate signal lines and the source signal lines. In the case of a horizontal alignment mode, such a structure further includes components such as a common conductive line and a counter electrode connected to the common conductive line.

TFTs having a channel layer formed from amorphous silicon, polysilicon, or indium-gallium-zinc-oxide (IGZO; oxide semiconductor) are preferably used. The amount of off-leakage current is small particularly with oxide semiconductors. Thus, the oxide semiconductors are advantageous in low-frequency driving of liquid crystal display devices, but the low-frequency driving is not feasible when the VHR is low. According to this embodiment, it is possible to increase the VHR, thus enabling low-frequency driving. In other words, a combination of an oxide semiconductor and this embodiment is considered to be particularly preferred.

The color filter substrate may be one that is commonly used in the field of liquid crystal panels. The structure of the color filter substrate includes, for example, a black matrix in a grid pattern and color filters each formed within a cell of the grid (i.e., pixels) formed on a transparent substrate.

The color filters and the active matrix may both be formed on one of the substrates 10.

The method for producing a liquid crystal panel of Embodiment 1 includes the step of forming a film containing a polymer having a structure represented by the following formula (1) on a surface of at least one of the substrates 10. In the formula (1), the dotted lines are monovalent linking groups, and each may be bonded to a functional group such as a —H or —CH₃ group, or may be bonded to the main chain or side chain of the polymer.

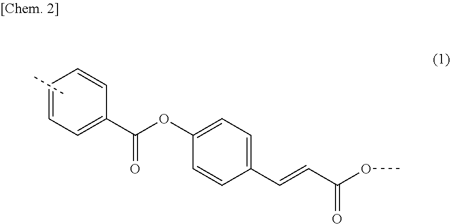

Another aspect of the present invention may be a horizontal photo-alignment film material having a structure represented by the formula (1). The structure represented by the formula (1) contains a cinnamate as a photo-reactive moiety (hereinafter also referred to as a photo-functional group). Light irradiation causes photoreaction (photoisomerization and/or photodimerization) of the cinnamate as shown in the following reaction formula, whereby a pre-tilt angle can be given to liquid crystal molecules.

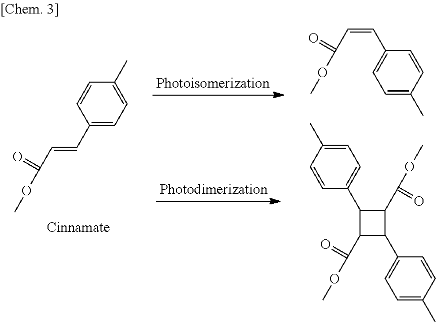

The cinnamate photoreaction is dependent on the irradiation dose. At a low irradiation dose, photoisomerization mainly occurs, and at a high irradiation dose, photodimerization mainly occurs. The low irradiation dose means, for example, when the irradiating light has a wavelength of 313 nm, an irradiation dose of 200 mJ/cm² or lower. The high irradiation dose means, for example, when the irradiating light has a wavelength of 313 nm, an irradiation dose of higher than 200 mJ/cm². In Non-Patent Literature 1, the two-step irradiation seems to be conducted at a wavelength of 313 nm and an irradiation dose of 1 J/cm² or higher, which indicates that the study was made on an optimal method for giving a pre-tilt angle in the irradiation dose range in which photodimerization mainly occurs. Meanwhile, the present inventors have found out that an optimal method for giving a pre-tilt angle in the irradiation dose range in which photoisomerization mainly occurs is different from conventional methods. In Embodiment 1, the film is irradiated with S-polarized light from a direction oblique to the normal to the substrate surface. This enables the formation of a pre-tilt angle by one-step irradiation. The structure represented by the formula (1) is preferably photoisomerized by the S-polarized light irradiation.

The structure represented by the formula (1) has high exposure sensitivity as compared with cinnamic acid having a simple structure. The structure represented by the formula (1) also has a high ability to align liquid crystal molecules because it has a structure very similar to that of the mesogen of a liquid crystal molecule.

The polymer may have the structure represented by the formula (1) in a side chain. The presence of the structure represented by the formula (1) in a side chain leads to a photo-alignment film having a higher exposure sensitivity.

The polymer may have a main chain derived from at least one polymer selected from the group consisting of a polyamic acid, a polyimide, a polysiloxane, a polyacrylic acid, and polymethacrylic acid. The selection of the polymer may be made from the standpoint of heat resistance and electric properties.

The polyamic acid, for example, may contain a repeating structural unit represented by the following formula (2):

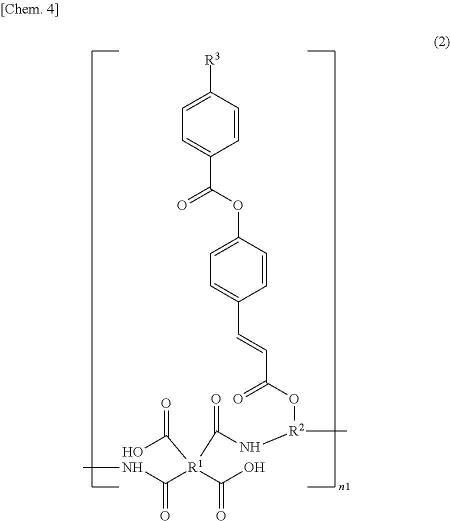

wherein n1 represents the degree of polymerization and is an integer of 1 or greater.

The repeating structural unit represented by the formula (2) has a main chain derived from a polyamic acid and has a structure represented by the formula (1) in a side chain. R¹ is a tetravalent organic group, and examples thereof include structures represented by the following formulae (R1-1) to (R1-7). In the formulae (R1-1) to (R1-7), the dotted lines are linking groups.

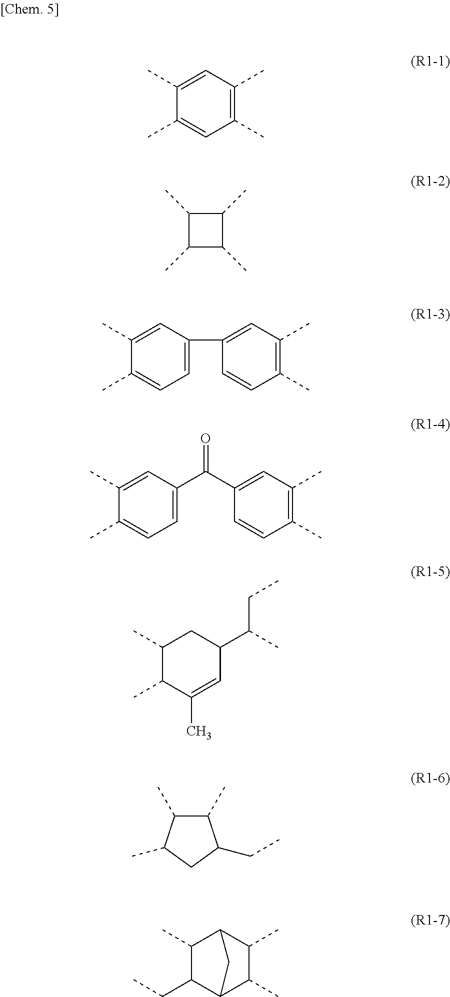

R² is a trivalent organic group. Examples thereof include structures represented by the following formula (R2-1) and (R2-2). In the formula (R2-1) and (R2-2), the dotted lines are linking groups.

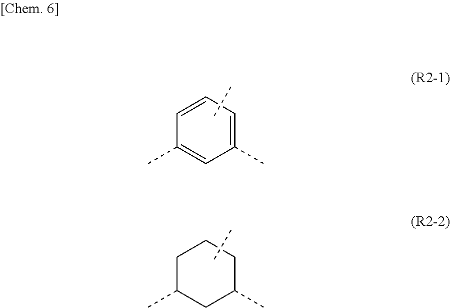

R³ is a monovalent functional group. Examples thereof include —F, —Cl, —Br, —CN, —NCS, —SCN, —OH, and —COOH.

In the polyamic acid, a functional group capable of substantially horizontally aligning liquid crystal molecules without light irradiation (hereinafter also referred to as a horizontally aligning functional group) may be introduced as a side chain in a part of the repeating structural unit represented by the formula (2).

Specific examples of the horizontally aligning functional group include structures represented by the following formulae (3-1) to (3-8).

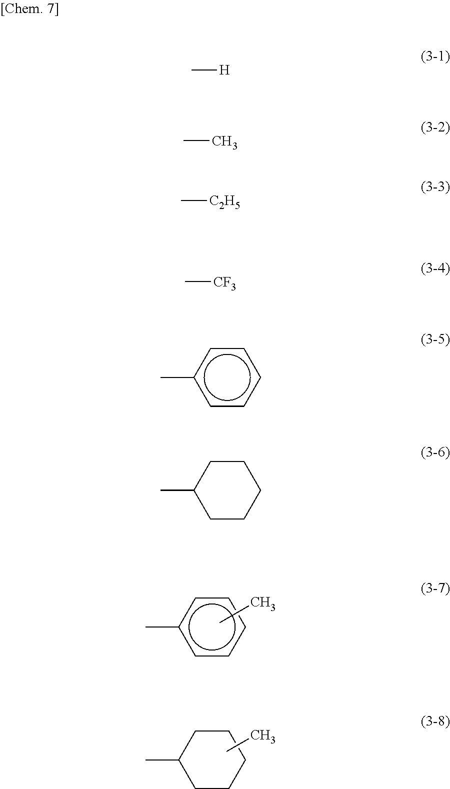

The polysiloxane may contain, for example, a repeating structural unit represented by the formula (4):

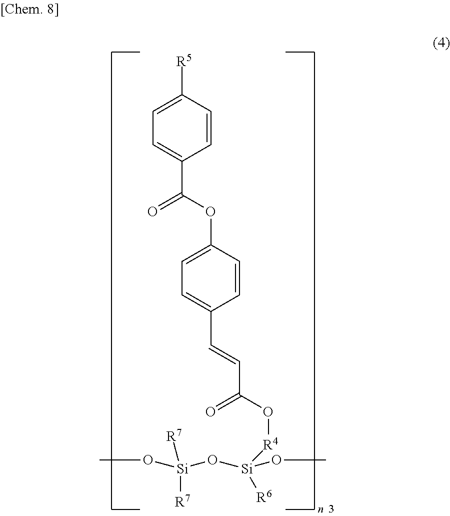

wherein n3 represents the degree of polymerization and is an integer of 1 or greater.

The repeating structural unit represented by the formula (4) has a main chain derived from a polysiloxane and has a structure represented by the formula (1) in a side chain. R⁴ is a divalent organic group and may be a saturated aliphatic hydrocarbon. An oxygen atom may be added to or substituted for part of the saturated aliphatic hydrocarbon. R⁵ is a monovalent organic group. Examples thereof include —F, —Cl, —Br, —CN, —NCS, —SCN, —OH, and —COOH. R⁶, R⁷, and R⁸ are each a monovalent organic group, and may be a saturated aliphatic hydrocarbon. An oxygen atom may be added to or substituted for part of the saturated aliphatic hydrocarbon. R⁶, R⁷, and R⁸ may be the same as or different from one another.

The horizontal photo-alignment film material may further contain a curing agent, a curing accelerator, a catalyst, and the like. The horizontal photo-alignment film may also contain a common polymer for alignment films that does not contain a photo-reactive functional group, so as to improve the solution characteristics of the alignment film material or the electrical characteristics of the alignment film.

The step of forming a film containing a polymer having a structure represented by the formula (1) may include, for example, a step of applying an alignment film material containing a polymer having a structure represented by the formula (1) onto surfaces of the paired substrates 10, and a step of heating the substrates 10 with the alignment film material applied thereto.

The alignment film material may be applied by any method. Examples of the method include a roll coater method, a spinner method, a printing method, and an ink-jet method. Heating the substrates 10 can volatilize the solvent in the alignment film material. The heating may be performed in two steps including prebaking and post-baking.

The method for producing a liquid crystal panel of Embodiment 1 includes the step of irradiating the film with S-polarized light from a direction oblique to the normal to the substrate surface to perform alignment treatment on the film and thereby form a horizontal photo-alignment film. The film is alignment-treated by the S-polarized light irradiation (exposure) and thus exhibits an alignment-controlling force. The alignment-controlling force refers to the ability of regulating the alignment of liquid crystal molecules near the alignment film.

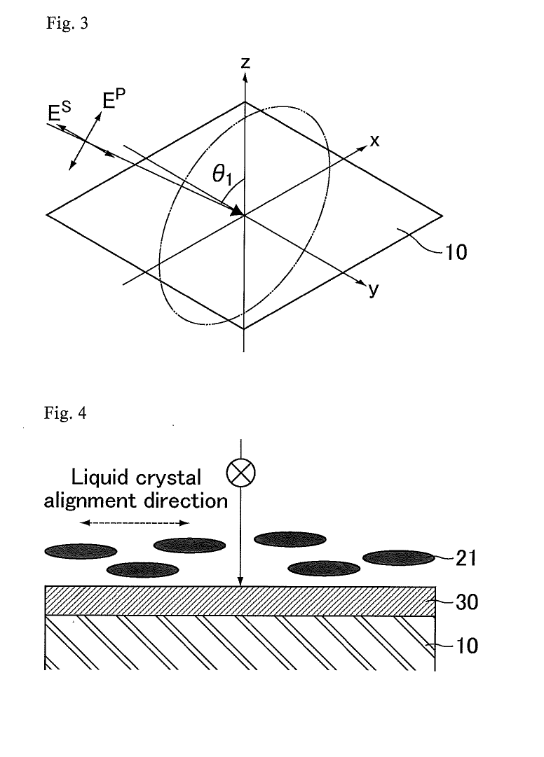

FIG. 2 is a view illustrating an S-polarized light irradiation method. In FIG. 2, z indicates the normal to a substrate surface. An arrow E^{S} indicates the irradiation direction of S-polarized light, and the symbol on the arrow indicates that the electric field vector of the S-polarized light is perpendicular to the plane of the paper. As shown in FIG. 2, the film is irradiated with S-polarized light (E^{S}) from a direction (angle: θ1) oblique to the normal z to the substrate surface. FIG. 3 is a view illustrating S-polarized light. As shown in FIG. 3, in polarized light irradiation of the xy plane from an oblique direction, when the plane of incidence (plane including incident light and the normal z) is defined as a xz plane, the electric field vector of S-polarized light vibrates perpendicularly to the plane of incidence (xz plane) and the electric field vector of P-polarized light vibrates parallel to the plane of incidence (xz plane) (i.e., in the plane of incidence).

In the horizontal photo-alignment film 30, the side chains that control the alignment of the liquid crystal molecules are oriented in all the directions in the plane of the substrate, and the absorption axes of the structures represented by the formula (1) are also oriented in all the directions in the plane of the substrate. Since the electric field vector of S-polarized light vibrates perpendicularly to the plane of incidence, the electric field vector of S-polarized light always coincides with at least some of the absorption axes of the structures represented by the formula (1) even when the film is irradiated with S-polarized light from a direction oblique to the normal to the substrate surface. This results in strong photoreaction (mainly photoisomerization). The absorption axis of a structure represented by the formula (1) is parallel to the longitudinal direction of the structure represented by the formula (1).

The present inventors focused on the fact that the symmetry of the alignment treatment direction is involved in the formation of a pre-tilt angle. With S-polarized light, the liquid crystal molecules are aligned in the xz plane shown in FIG. 3, since the horizontal photo-alignment film 30 aligns the liquid crystal molecules perpendicularly to the polarization direction of light applied from the substrate normal. For formation of a pre-tilt angle in the xz plane, an alignment treatment asymmetric with respect to the z-axis is required. In the present embodiment, irradiation is performed from a direction asymmetric (oblique) with respect to the z-axis, so that a pre-tilt angle is formed. The formation of a pre-tilt angle enables uniform alignment of liquid crystal molecules upon voltage application to the liquid crystal layer, thus reducing the occurrence of disclination. With P-polarized light, liquid crystal molecules are aligned on the y-axis in the yz plane. For formation of a pre-tilt angle in the yz plane, an alignment treatment asymmetric with respect to the z-axis is required; however, with P-polarized light irradiation, which is irradiation from a direction perpendicular to the substrate in the yz plane, a pre-tilt angle cannot be formed even if the irradiation is performed from a direction asymmetric (oblique) with respect to the z-axis.

The S-polarized light irradiation angle is preferably 10° or greater and 80° or smaller with respect to the normal to the substrate surface. The irradiation angle within the range makes it possible to efficiently give a pre-tilt angle. The lower limit of the irradiation angle is more preferably 30° and the upper limit thereof is more preferably 50°.

The extinction ratio of the S-polarized light may be 7 or higher. The extinction ratio is calculated from the ratio (Tmax/Tmin) of a maximum transmittance (Tmax) obtained when a linear polarizer is aligned along the polarization axis to a minimum transmittance (Tmin) obtained when the polarizer is rotated 90 degrees. When the extinction ratio of the S-polarized light is 7, it is possible to control the pre-tilt angle of liquid crystal molecules with respect to the horizontal alignment film, and it is also possible to reduce the occurrence of disclination. The upper limit of the extinction ratio is not limited because the pre-tilt angle that can be given is unchanged even if the extinction ratio of the S-polarized light is set to 7 or higher.

The S-polarized light may have a wavelength of 270 nm or longer and 340 nm or shorter. Within this wavelength range, the structure represented by the formula (1) undergoes a structural change and thus exhibits alignment-controlling force. The S-polarized light irradiation dose may be 1 mJ/cm² or higher and 200 mJ/cm² or lower. When the irradiation dose is within the range, the photoisomerization of the structure represented by the formula (1) predominates, allowing the formation of a pre-tilt angle by one-step S-polarized light irradiation.

The horizontal photo-alignment film 30 aligns liquid crystal molecules perpendicularly to the polarization direction of light applied from the substrate normal. The light applied from the substrate normal is linearly polarized light. As described above with reference to FIG. 3, P-polarized light and S-polarized light are defined by the vibration direction of the electric field vector with respect to the plane including incident light and the normal z. The polarized light applied from the substrate normal thus cannot be defined as P-polarized light nor S-polarized light. The polarization direction of the light is the vibration direction of the electric field vector of light applied from the substrate normal. To describe the alignment azimuth of liquid crystal molecules, polarized light irradiation from the normal direction of the substrate surface will be described below with reference to FIG. 4. FIG. 4 is a view illustrating the relation between the polarization direction of light applied from the substrate normal and the alignment azimuth of liquid crystal molecules. In FIG. 4, the solid arrow indicates the irradiation direction of polarized light. The symbol on the solid arrow indicates that the electric field vector of the polarized light is perpendicular to the plane of the paper. As shown in FIG. 4, upon irradiation with polarized light from the normal direction of the substrate surface, liquid crystal molecules 21 are aligned perpendicularly to the polarization direction (parallel to the plane of the paper) since the electric field vector of the polarized light is perpendicular to the plane of the paper. In FIG. 4, the liquid crystal molecules 21 are aligned parallel to the substrate. In Embodiment 1, however, the liquid crystal molecules 21 have a pre-tilt angle with respect to the substrate surface because of irradiation with S-polarized light from a direction (angle: θ1) oblique to the normal z to the substrate surface. Whether the horizontal photo-alignment film 30 aligns liquid crystal molecules perpendicularly to the polarization direction of light applied from the substrate normal can be determined by measuring the refractive index anisotropy or absorption anisotropy before and after the irradiation with polarized light.

Examples of the horizontal photo-alignment film that aligns liquid crystal molecules perpendicularly to the polarization direction of light applied from the substrate normal include those having a structure such as azobenzene, stilbene, cinnamate, chalcone or cyclobutane.

The horizontal photo-alignment films 30 may be subjected to division alignment treatment to form multiple alignment regions.

The horizontal photo-alignment films 30 substantially horizontally align the liquid crystal molecules in the liquid crystal layer 20. When the voltage applied to the liquid crystal layer 20 is lower than the threshold voltage (including no voltage application), the alignment of the liquid crystal molecules in the liquid crystal layer 20 is controlled mainly by the function of the horizontal photo-alignment films 30. An angle formed by the major axes of the liquid crystal molecules with respect to the surfaces of the substrates 10 in this state (hereinafter also referred to as an “initial alignment state”) is referred to as a “pre-tilt angle”. The term “pre-tilt angle” as used herein indicates the angle of tilt of the liquid crystal molecules from the direction parallel to the substrate surfaces. The angle parallel to the substrate surfaces is 0°, and the angle normal to the substrate surfaces is 90°. When the liquid crystal molecules are substantially horizontally aligned, the pre-tilt angle is preferably smaller than 20°.

Next, a liquid crystal composition is placed between the photo-alignment treated substrates 10 by vacuum filling or one drop filling to form the liquid crystal layer 20. In the case of vacuum filling, application of a sealant 40, attachment of the substrates 10, curing of the sealant 40, filling with the liquid crystal composition, and sealing of the filling port are performed in this order. Thus, the liquid crystal composition is sealed between the substrates 10 to form the liquid crystal layer. In the case of one drop filling, application of a sealant, dropping of the liquid crystal composition, attachment of the substrates 10, and curing of the sealant 40 are performed in this order. Thus, the liquid crystal composition is sealed between the substrates 10 to form the liquid crystal layer 20.

The liquid crystal composition is not particularly limited as long as it contains at least one type of liquid crystal material, usually a thermotropic liquid crystal, preferably a liquid crystal material (nematic liquid crystal) that exhibits the nematic phase. The liquid crystal composition may further contain a chiral agent. Examples of the chiral agent include cholesterol and S811 (Merck).

The anisotropy of dielectric constant (Δε) of the liquid crystal material, which is defined by the formula shown below, may be negative or positive. In other words, the liquid crystal molecules may have negative anisotropy of dielectric constant or positive anisotropy of dielectric constant. As the liquid crystal molecules having negative anisotropy of dielectric constant, for example, those having Δε of −1 to −20 can be used. As the liquid crystal molecules having positive anisotropy of dielectric constant, for example, those having Δε of 1 to 20 can be used. For the TN mode and ECB mode liquid crystal display devices described later, liquid crystal molecules having negative anisotropy of dielectric constant are preferred. For IPS mode and FFS mode liquid crystal display devices, liquid crystal molecules having negative anisotropy of dielectric constant are preferred. The liquid crystal layer 20 may further contain non-polar liquid crystal molecules (neutral liquid crystal molecules) in which Δε is substantially 0. Examples of the neutral liquid crystal molecules include liquid crystal molecules having an alkene structure.

Δε=(Dielectric constant in major axis direction)−(Dielectric constant in minor axis direction)

The sealant 40 is disposed to surround the liquid crystal layer 20. The material of the sealant 40 may be an epoxy resin containing inorganic or organic filler and a curing agent. The sealant 40 may be a photocurable sealant that is cured by ultraviolet light or the like, or may be a thermally curable sealant that is cured by heat.

In the liquid crystal panel 100, a polarizing plate (linear polarizer) 50 may be disposed on each of the substrates on the side opposite to the liquid crystal layer 20. The polarizing plate 50 may typically be one obtained by aligning a dichroic anisotropic material such as an iodine complex adsorbed on a polyvinyl alcohol (PVA) film. Generally, each surface of the PVA film is laminated with a protective film such as a triacetyl cellulose film before the film is put into practical use. An optical film such as a retardation film may be disposed between the polarizing plate 50 and each of the substrates 10.

The liquid crystal panel 100 of the present embodiment can be used in a liquid crystal display device. The above steps are followed by attachment of components such as a control unit, a power supply unit, and a backlight. Thus, a liquid crystal display device is completed.

The backlight may be disposed on the back side of the liquid crystal panel 100. The liquid crystal display device having such a structure is generally referred to as a transmissive liquid crystal display device. The backlight 80 is not particularly limited as long as it emits light including visible light. It may be one that emits light including only visible light, or may be one that emits light including both visible light and ultraviolet light. The term “visible light” refers to light having a wavelength of 380 nm or longer and shorter than 800 nm (electromagnetic waves).

Members other than those described above are not particularly limited, and those commonly used in the field of liquid crystal display devices may be used. Thus, the descriptions of such components are omitted.

The display mode of the liquid crystal display device is not limited as long as the liquid crystal display device includes a horizontal photo-alignment film. Examples of the display mode include a twisted nematic (TN) mode, an in-plane switching (IPS) mode, a fringe field switching (FFS) mode, and an electrically controlled birefringence (ECB) mode.

Each feature described for the above embodiment of the present invention is applicable to all the aspects of the present invention.

The present invention is described below in more detail with reference to examples and comparative examples.

The examples, however, are not intended to limit the scope of the present invention.

### Example 1

### (Preparation of Horizontal Alignment Film Material)

A polyamic acid (3% by weight) was dissolved in a solvent containing N-methyl-2-pyrrolidone (NMP) and butyl cellosolve (BC) at a ratio of 7:3, whereby a polyamic acid solution containing a repeating structural unit represented by the following formula (2) was obtained.

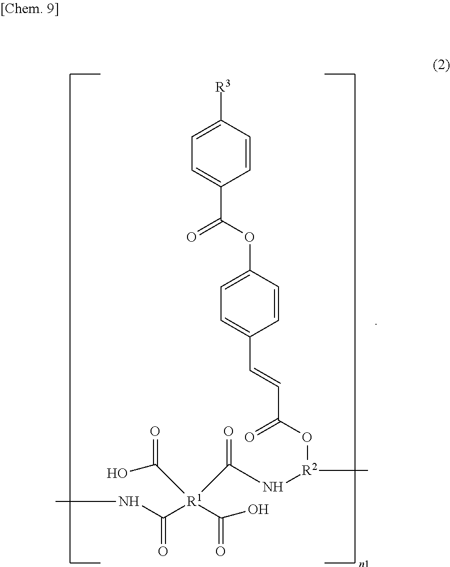

In the formula, n1 represents the degree of polymerization and is an integer of 1 or greater.

The repeating structural unit represented by the formula (2) has a main chain derived from a polyamic acid and has a structure represented by the formula (1) in a side chain. R¹ may be any of the structures represented by the formulae (R1-1) to (R1-7). R² is a structure represented by the formula (R2-1) or (R2-2). R³ may be any of —F, —Cl, —Br, —CN, —NCS, —SCN, —OH, and —COOH.

### (Production of Liquid Crystal Panel)

An ECB mode liquid crystal panel was actually prepared in the following manner.

A TFT substrate and a CF substrate were prepared. The TFT substrate included components such as indium tin oxide (ITO) pixel electrodes, TFTs, and conductive lines. The CF substrate included components such as an indium tin oxide (ITO) counter electrode, color filters, and black matrix. The alignment film material obtained above was applied to the TFT substrate and CF substrate and pre-dried at 90° C. for one minute. The dried film thickness was 100 nm. Thereafter, the substrates were post-baked at 200° C. for 40 minutes. The resulting horizontal photo-alignment films were capable of aligning liquid crystal molecules perpendicularly to the polarization direction of light applied from the substrate normal.

Subsequently, the surfaces of the TFT substrate and CF substrate to which the alignment film material was applied were exposed to light such that the pre-tilt azimuths of liquid crystal molecules were anti-parallel. The exposure was performed using a DEEP UV lamp available from Ushio Inc. with S-polarized light at a wavelength of 313 nm and 20 mJ/cm². The extinction ratio of S-polarized light was 100. The angle of incidence of S-polarized light was 40° from the substrate normal.

Then, to one of the substrates was applied a UV-curable sealant (Sekisui Chemical Co., Ltd., product name: Photolec S-WB) in a predetermined pattern using a dispenser. Onto a predetermined position of the other substrate was dropped a liquid crystal composition. The liquid crystal composition contained a liquid crystal material having positive anisotropy of dielectric constant (Merck, MLC3019). The substrates were attached to each other in a vacuum. The sealant was cured by ultraviolet light irradiation with the display area shielded from the light. The TFT substrate and CF substrate were thus bonded to each other. Finally, a polarizing plate was attached to the outside of each of the TFT substrate and CF substrate with the transmission axes perpendicular to each other, whereby an ECB mode liquid crystal panel was prepared.

The pre-tilt angle in the liquid crystal panel of Example 1 was measured and found to be 0.4°. The pre-tilt angle was measured by a crystal rotation method. A voltage (3 V) was applied to the liquid crystal layer and the liquid crystal layer was observed with a polarization microscope BX51 available from Olympus Corp. The observation showed no disclination. In Example 1, an ECB mode liquid crystal panel with no disclination and no luminance unevenness was obtained.

### Comparative Example 1

An ECB mode liquid crystal panel of Comparative Example 1 was prepared as in Example 1 except that a different alignment film material was used.

### (Preparation of Horizontal Alignment Film Material)

A polyvinyl cinnamate (3% by weight) represented by the following formula (5) was dissolved in a solvent containing N-methyl-2-pyrrolidone (NMP) and butyl cellosolve (BC) at a ratio of 7:3, whereby a polyvinyl cinnamate solution was obtained.

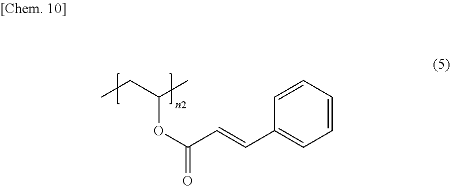

In the formula, n2 represents the degree of polymerization and is an integer of 1 or greater.

The resulting horizontal photo-alignment films were capable of aligning liquid crystal molecules perpendicularly to the polarization direction of light applied from the substrate normal. The pre-tilt angle in the liquid crystal panel of Comparative Example 1 was measured and found to be 0.0°. The pre-tilt angle was measured by a crystal rotation method. In Comparative Example 1, no pre-tilt angle was formed. Many disclination defects occurred upon application of a voltage (3 V) to the liquid crystal layer.

The results of Comparative Example 1 show that the formation of a pre-tilt angle is dependent on the alignment film material. Cinnamic acids having a simple structure such as one used in Comparative Example 1 have a low exposure sensitivity or low ability to align liquid crystal molecules. Such cinnamic acids thus seem unable to align liquid crystal molecules in the irradiation range where photoisomerization mainly occurs.

On the basis of Comparative Examples 2 to 4, a study was made on the combination of the type of irradiating light (P-polarized light or S-polarized light) and the type of the alignment film (horizontal photo-alignment film or vertical photo-alignment film).

### Comparative Example 2

An ECB mode liquid crystal panel of Comparative Example 2 was prepared as in Example 1 except that a different alignment film material and a different liquid crystal composition were used.

### (Preparation of Vertical Alignment Film Material)

A polyamic acid (3% by weight) was dissolved in a solvent containing N-methyl-2-pyrrolidone (NMP) and butyl cellosolve (BC) at a ratio of 7:3, whereby a polyamic acid solution containing a repeating structural unit represented by the following formula (6) was obtained.

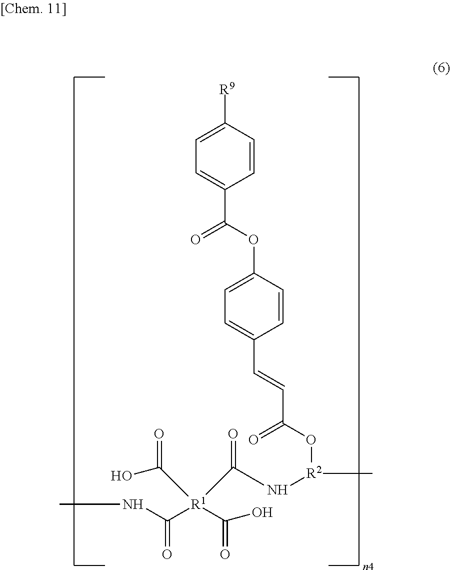

In the formula, n4 represents the degree of polymerization and is an integer of 1 or greater.

The repeating structural unit represented by the formula (6) has a main chain derived from a polyamic acid and has a structure represented by the formula (1) in a side chain. R¹ may be any of the structures represented by the formulae (R1-1) to (R1-7). R² is a structure represented by the formula (R2-1) or (R2-2). R⁹ is a C3-C15 hydrocarbon chain. In the hydrocarbon chain, one or more of the hydrogen atoms may be replaced with a fluorine atom, and one or more of the carbon atoms may be replaced with an oxygen atom.

The liquid crystal composition contained a liquid crystal material having negative anisotropy of dielectric constant (Merck, MLC6610).

The resulting vertical photo-alignment films were capable of aligning liquid crystal molecules perpendicularly to the polarization direction of light applied from the substrate normal. That is, the major axis of the anisotropy of the alignment films exhibited due to the photo-alignment treatment was perpendicular to the polarization direction. The pre-tilt angle of the liquid crystal panel according to Comparative Example 2 was measured and found to be 90.0°. The pre-tilt angle was measured with Optipro (rotating analyzer method) available from Shintech Inc. The results show that with the combination of the alignment film material and the liquid crystal material used in Comparative Example 2, whether or not the alignment films is exposed to light does not affect the formation of the pre-tilt angle. In addition, disclination occurred upon application of a voltage (3 V) to the liquid crystal layer.

The alignment of the liquid crystal molecules is controlled by the side chains near the outermost surfaces of the alignment films. In a vertical photo-alignment film, the side chains are oriented in the substrate normal direction, and the absorption axes of the photo-functional groups of the side chains are also considered to be averagely oriented in the substrate normal direction. Since the substrate normal direction is perpendicular to the electric field vector of the irradiating S-polarized light, the electric field vector was seemingly hardly absorbed by the absorption axes of the photo-functional groups in the S-polarized light exposure. Thus, photoreaction did not occur, failing to change the pre-tilt angle.

### Comparative Example 3

An ECB mode liquid crystal panel of Comparative Example 3 was prepared as in Example 1 except that a different alignment film material and a different liquid crystal composition were used, and that the exposure was performed with P-polarized light. In Comparative Example 3, the vertical alignment film material and liquid crystal composition used in Comparative Example 2 were used.

The surfaces of the TFT substrate and CF substrate to which the alignment film material was applied were exposed to light such that the pre-tilt azimuths of liquid crystal molecules were anti-parallel. The surfaces were irradiated with P-polarized light at a wavelength of 313 nm and 20 mJ/cm². The extinction ratio of P-polarized light was 100. The angle of incidence of P-polarized light was 40° from the substrate normal.

The pre-tilt angle in the liquid crystal panel according to Comparative Example 3 was measured and found to be 88.8°. The pre-tilt angle was measured with Optipro (rotating analyzer method) available from Shintech Inc. Upon application of a voltage (3 V) to the liquid crystal layer, the liquid crystal molecules were uniformly aligned, and no disclination was observed.

In Comparative Example 3, the pre-tilt angle was changed from 90° to 88.8°. In Comparative Example 3, where vertical photo-alignment films were used, the side chains were oriented in the substrate normal direction, and the absorption axes of the photo-functional groups of the side chains are also considered to have been averagely oriented in the substrate normal direction. The substrate normal forms an angle of 40° with the electric field vector of the irradiating P-polarized light. The absorption axes of the functional groups of the side chains thus form a degree of 40° with the electric field vector of the irradiating P-polarized light. Even when the absorption axes of the functional groups of the side chains and the electric field vector form an angle of 40°, there are some moments when the absorption axes of the functional groups become parallel to the electric field vector due to thermal fluctuations with time of the side chains. This seemingly allowed the formation of the pre-tilt angle in Comparative Example 3. Comparison between Comparative Example 2 and Comparative Example 3 shows that as for a vertical photo-alignment film, P-polarized light exposure is more likely to cause photoreaction of the photo-functional groups than S-polarized light exposure.

### Comparative Example 4

An ECB mode liquid crystal panel of Comparative Example 4 was prepared as in Example 1 except that P-polarized light was used for the exposure.

The surfaces of the TFT substrate and CF substrate to which the alignment film material was applied were exposed to light such that the pre-tilt azimuths of liquid crystal molecules were anti-parallel. The surfaces were irradiated with P-polarized light at a wavelength of 313 nm and 20 mJ/cm². The extinction ratio of P-polarized light was 100. The angle of incidence of P-polarized light was 40° from the substrate normal.

The pre-tilt angle in the liquid crystal panel according to Comparative Example 4 was measured and found to be 0.0°. The pre-tilt angle was measured by a crystal rotation method. In Comparative Example 4, no pre-tilt angle was formed and many disclination defects occurred upon application of a voltage (3 V) to the liquid crystal layer.

In Comparative Example 4, horizontal photo-alignment films were used. Since the horizontal photo-alignment films align liquid crystal molecules in a direction perpendicular to the electric field vector, the films seemingly failed to form a pre-tilt angle because of the electric field vector of the P-polarized light and the symmetry of the system.

The results of Example 1 and Comparative Examples 2 to 4 were shown in Table 1.

TABLE 1

| | Type of | Type of | Pre-tilt |
|---|---|---|---|
| | irradiating light | alignment film | angle change |
| Example 1 | S-polarized light | Horizontal photo- | Changed |
| | | alignment film | |
| Comparative | S-polarized light | Vertical photo- | Not changed |
| Example 2 | | alignment film | |
| Comparative | P-polarized light | Vertical photo- | Changed |
| Example 3 | | alignment film | |
| Comparative | P-polarized light | Horizontal photo- | Not changed |
| Example 4 | | alignment film | |

While irradiation of a vertical photo-alignment film with P-polarized light is known, the results of Comparative Example 4 show that irradiation of a horizontal photo-alignment film with P-polarized light does not change the pre-tilt angle. Meanwhile, the results of Comparative Example 2 show that irradiation of a vertical photo-alignment film with S-polarized light does not change the pre-tilt angle. As shown in Table 1, the change in the pre-tilt angle is derived from the relation between the type of irradiating light, the exposure direction, and the alignment film material that absorbs the irradiating light. Arriving at it requires a complicated process. In addition, as described above, changing the pre-tilt angle also requires a high sensitivity of the alignment film material derived from the structure of the photo-functional group. This point is also not easy to arrive at.

### Example 2

An ECB mode liquid crystal panel of Example 2 was prepared as in Example 1 except that a different alignment film material was used.

### (Preparation of Horizontal Alignment Film Material)

A polysiloxane (3% by weight) was dissolved in a solvent containing N-methyl-2-pyrrolidone (NMP) and butyl cellosolve (BC) at a ratio of 7:3, whereby a polysiloxane solution containing a repeating structural unit represented by the following formula (4) was obtained.

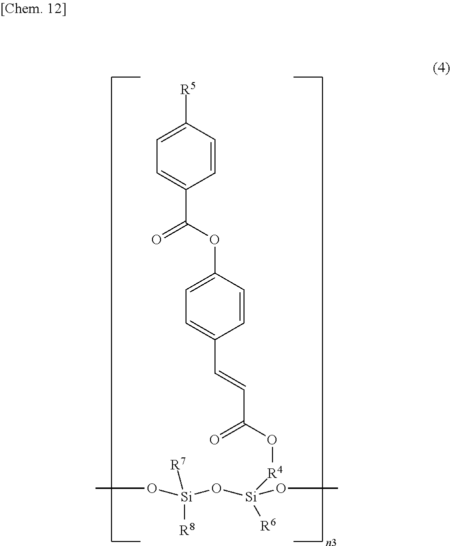

In the formula, n3 represents the degree of polymerization and is an integer of 1 or greater.

The repeating structural unit represented by the formula (4) has a main chain derived from a polysiloxane and has a structure represented by the formula (1) in a side chain. R⁴ may be a saturated aliphatic hydrocarbon. An oxygen atom may be added to or substituted for part of the aliphatic hydrocarbon. R⁵ may be —F, —Cl, —Br, —CN, —NCS, —SCN, —OH, or —COOH. R⁶, R⁷, and R⁸ each may be a saturated aliphatic hydrocarbon. An oxygen atom may be added to or substituted for part of the aliphatic hydrocarbon.

The resulting horizontal photo-alignment films were capable of aligning liquid crystal molecules perpendicularly to the polarization direction of light applied from the substrate normal. The pre-tilt angle of the liquid crystal panel according to Example 2 was measured and found to be 0.3°. The pre-tilt angle was measured by a crystal rotation method. No disclination was observed upon application of a voltage (3 V) to the liquid crystal layer. In Example 2, an ECB mode liquid crystal panel with no disclination and no luminance unevenness was obtained.

The results of Example 2 show that the main chain of the alignment film material is not limited, and that any horizontal photo-alignment film can give a pre-tilt angle to liquid crystal molecules as long as it has a structure represented by the formula (1) and aligns liquid crystal molecules perpendicularly to the polarization direction of light applied from the substrate normal.

### Comparative Example 5

An ECB mode liquid crystal panel of Comparative Example 5 was prepared as in Example 1 except that the surfaces of the TFT substrate and CF substrate to which the alignment film material was applied were exposed to non-polarized light. The extinction ratio of non-polarized light was 1.

### Examples 3 to 5

ECB mode liquid crystal panels of Examples 3 to 5 were prepared as in Example 1 except that the extinction ratio was changed. The extinction ratios in Examples 3 to 5 were 2, 7, and 30, respectively.

The pre-tilt angles in the liquid crystal panels of Examples 1 and 3 to 5 and Comparative Example 5 were measured by a crystal rotation method. The presence or absence of disclination was also examined with a polarization microscope BX51 available from Olympus Corp. Table 2 shows the results.

TABLE 2

| | | Pre-tilt | Presence or absence |
|---|---|---|---|
| | Extinction ratio | angle | of disclination |
| Comparative | 1 (Non-polarized light) | 0.1° | Present |
| Example 5 | | | |
| Example 3 | 2 | 0.2° | Absent |
| Example 4 | 7 | 0.4° | Absent |
| Example 5 | 30 | 0.4° | Absent |
| Example 1 | 100 | 0.4° | Absent |

The results of Comparative Example 5 show that with an extinction ratio of 1 (non-polarized light), a slight pre-tilt angle is formed but disclination occurs. The results of Examples 1 and 3 to 5 show that irradiation with S-polarized light forms a pre-tilt angle and reduces the occurrence of disclination. The results also show that when the extinction ratio of S-polarized light is 7 or higher, the pre-tilt angle does not exceed 0.4° even if the extinction ratio is increased. Thus, the extinction ratio of S-polarized light is preferably 7 or higher.

### [Additional Remarks]

One aspect of the present invention may be a method for producing a liquid crystal panel including paired substrates, a liquid crystal layer between the substrates, and a horizontal photo-alignment film between at least one of the substrates and the liquid crystal layer, the method including the steps of: forming a film containing a polymer having a structure represented by the following formula (1):

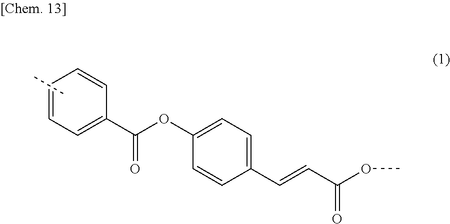

on a surface of at least one of the substrates; and irradiating the film with S-polarized light from a direction oblique to the normal to the substrate surface to perform an alignment treatment on the film and thereby form a horizontal photo-alignment film, wherein the horizontal photo-alignment film aligns liquid crystal molecules perpendicularly to the polarization direction of light applied from the substrate normal.

The irradiation with the S-polarized light may cause photoisomerization of the structure represented by the formula (1).

The irradiation angle of the S-polarized light may be 10° or greater and smaller than 80° with respect to the normal to the substrate surface.

The polymer may have a main chain derived from at least one polymer selected from the group consisting of a polyamic acid, a polyimide, a polysiloxane, a polyacrylic acid, and a polymethacrylic acid.

The polymer may have the structure represented by the formula (1) in a side chain.

The extinction ratio of the S-polarized light may be 7 or higher.

Another aspect of the present invention may be a horizontal photo-alignment film material having a structure represented by the following formula (1).

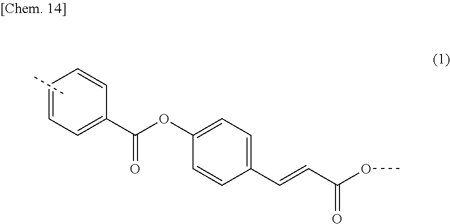

The embodiments of the present invention may be appropriately combined without departing from the gist of the present invention.

### REFERENCE SIGNS LIST

10: Substrate
20: Liquid crystal layer
21: Liquid crystal molecule
30: Horizontal photo-alignment film
40: Sealant
50: Polarizing plate
100: Liquid crystal panel

1. A method for producing a liquid crystal panel including paired substrates, a liquid crystal layer between the substrates, and a horizontal photo-alignment film between at least one of the substrates and the liquid crystal layer, the method comprising the steps of:
forming a film containing a polymer having a structure represented by the following formula (1): 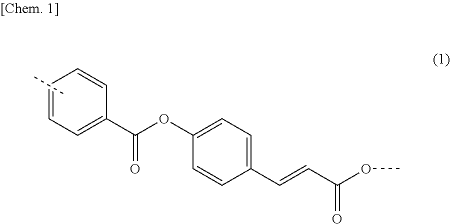
on a surface of at least one of the substrates; and
irradiating the film with S-polarized light from a direction oblique to the normal to the substrate surface to perform an alignment treatment on the film and thereby form a horizontal photo-alignment film,
wherein the horizontal photo-alignment film aligns liquid crystal molecules perpendicularly to the polarization direction of light applied from the substrate normal.

2. The method for producing a liquid crystal panel according to claim 1,
wherein the irradiation with the S-polarized light causes photoisomerization of the structure represented by the formula (1).

3. The method for producing a liquid crystal panel according to claim 1,
wherein the polymer has a main chain derived from at least one polymer selected from the group consisting of a polyamic acid, a polyimide, a polysiloxane, a polyacrylic acid, and a polymethacrylic acid.

4. The method for producing a liquid crystal panel according to claim 1,
wherein the polymer has the structure represented by the formula (1) in a side chain.

5. The method for producing a liquid crystal panel according to claim 1,
wherein the extinction ratio of the S-polarized light is 7 or greater.
